(19) United States
(12) Patent Application Publication
(10) Pub. No.: US 2022/0201174 A1
(43) Pub. Date: Jun. 23, 2022

(54) COMPOUND EYE-BASED IN-SITU MONITORING UNIT, MICRO-ADJUSTMENT UNIT, AND MULTI-SPECTRAL IMAGING SYSTEM THEREOF

(71) Applicants: Jilin University, Changchun (CN); Weihai Institute for Bionics-Jilin University, Weihai (CN)

(72) Inventors: Zhichao MA, Changchun (CN); Siguo YANG, Changchun (CN); Chaofan LI, Changchun (CN); Bin HUANG, Changchun (CN); Yue JIANG, Changchun (CN); Wei ZHANG, Changchun (CN); Shenghui WANG, Changchun (CN); Hairui DU, Changchun (CN); Zixin GUO, Changchun (CN); Jize LIU, Changchun (CN); Hongwei ZHAO, Changchun (CN); Luquan REN, Changchun (CN); Chuliang YAN, Changchun (CN)

(73) Assignees: Jilin University, Changchun (CN); Weihai Institute for Bionics-Jilin University, Weihai (CN)

(21) Appl. No.: 17/149,222

(22) Filed: Jan. 14, 2021

(30) Foreign Application Priority Data
Dec. 23, 2020 (CN) 202011534756.6

(51) Int. Cl. H04N 5/225; G01N 21/3581; G01N 21/65; H04N 5/247; G02B 7/02

(52) U.S. Cl. CPC H04N 5/2259; G01N 21/3581; G01N 21/65; G01N 2201/068; H04N 5/247; H04N 5/2256; G02B 7/02; H04N 5/2254

(57) ABSTRACT

The present disclosure provides a compound eye-based in-situ monitoring unit, a micro-adjustment unit, and a multi-spectral imaging system thereof. The compound eye-based in-situ monitoring unit includes a spherical installation cover and an imaging assembly disposed on the spherical installation cover, where the spherical installation cover is provided with a spherical grid array, the spherical grid array includes 20 installation points (five rows and four columns), one imaging assembly is installed on each installation point, the imaging assemblies include a charge coupled device (CCD) optical digital camera assembly, a digital image correlation (DIC) light source assembly, an infrared (IR) spectrum assembly, a Raman spectrum assembly, and a terahertz light source assembly.

### CROSS REFERENCE TO RELATED APPLICATION

This application claims the priority of Chinese Patent Application No. 202011534756.6, filed with the China National Intellectual Property Administration on Dec. 23, 2020, which is incorporated herein by reference in its entirety.

### TECHNICAL FIELD

The present disclosure relates to the field of precision instruments, and in particular, to a compound eye-based in-situ monitoring unit, a micro-adjustment unit, and a multi-spectral imaging system thereof.

### BACKGROUND

Insufficient support for key materials has become one of bottlenecks restricting the development of national economy. Material failure caused by an unclear material micro-damage mechanism is one of important causes for major accidents and loss of life and property. These problems are mainly caused by lack of material testing abilities. Materials and their products have complex working conditions when they are in service, and therefore are inevitably affected by a plurality of forms of loads. In-situ (In Situ) testing on mechanical properties of materials is a technology for testing mechanical properties of all types of solid materials. In a testing process, inherent mechanical property parameters of the materials need to be obtained, and high-resolution dynamic monitoring also needs to be performed on evolution of organizational structures of the materials under loads by using a scanning electron microscopy (SEM), an X-ray diffractometer (XRD), an atomic force microscope (AFM), a charge coupled device (CCD), and the like. The SEM focuses on high-resolution observation of a surface micro-structure and micro-morphology of a tested unit. A point-by-point amplified morphology image is formed on a surface of the tested unit by using a secondary electron that is excited when a high-power incident electron beam bombards the surface of the tested unit, to observe a surface morphology.

The SEM can also cooperate with an energy dispersive spectrometer (EDS) to analyze types and contents of elements in micro-domain compositions of the materials. The XRD focuses on analyzing diffraction patterns of the materials to obtain structures, morphologies, and like information of atoms or molecules inside the materials. A Raman spectrometer more focuses on qualitative analysis of a molecular structure and micron-level micro-domain detection of the tested unit. In addition, as a frequently-used morphology monitoring instrument, the AFM can be used to perform nanoscale-region morphology detection and nanomanipulation on the materials. The CCD is an important application carrier of optical imaging information of the surface of the tested unit. Compared with the SEM that still has a high imaging magnification under a long working distance, the CCD focuses on micro-observation of metallographic structures and morphologies, and the like of the materials. An in-situ testing instrument for micro-mechanical properties of the materials can be used together with the foregoing imaging apparatuses only when the in-situ testing instrument has a structure compatible with structures of all types of apparatuses having a spatially open loading environment and supports vacuum and electromagnetic compatibility with a closed vacuum loading environment of the SEM. However, a conventional material in-situ testing technology can be integrated with only one imaging characterization technology, to establish a correlation between a load and single spectral information. Rich information of structure evolution including surface structure evolution, inner structure evolution, macro-structure evolution, and micro-structure evolution cannot be obtained for the materials at the same time, in other words, it is difficult to thoroughly understand micro-failure, deformation and damage mechanisms of the materials.

Most of existing morphology characterization or image recognition technologies related to surface defect monitoring of the materials depend on a fixed imaging apparatus or a multi-degree-of-freedom rigidly-driven imaging apparatus. For example, the SEM has a fixed electron emitting fun and a mobile multi-axis loading platform, and a probe of the AFM supports multi-degree-of-freedom motion and high-precision positioning. Subject to loading space, clamping conditions, and complex external field structural interference, it is difficult to realize small-field-of-view and remote imaging and fast, wide-domain, and full-field-of-view imaging under limited conditions such as obvious structural interference by using the fixed imaging apparatus (for example, the electron gun of the SEM) or the multi-degree-of-freedom rigidly-driven imaging apparatus (for example, a piezoelectric multi-degree-of-freedom driving platform).

Bioimaging represented by imaging based on insects' compound eyes provides a new idea for multi-spectral in-situ monitoring. Each ommatidium of an insect's compound eye includes a cornea, a cone, a pigment cell, a retinal cell, a rod, and the like, and is an independent photosensitive unit. Each ommatidium is stimulated only by an optical signal from a single direction, and generates a dotted image. A larger quantity of ommatidia usually leads to a wider field of view. Generally, an insect can perceive light in a wavelength range of 300 nm to 650 nm based on its compound eye structure. A human's eyeball can rotate freely around a center of its vitreous body, to realize fast, wide-angle, and full-field-of-view image recognition through flexible traction of six eye muscles within extremely compact space. Therefore, to ensure long-term stability, durability and reliability of the materials and their products when they are in service, it is very important to research and develop a device that can be used to precisely test the micro-mechanical properties of the materials and synchronously obtain information about of evolution of morphologies, thermal fields, strains, compositions, and defects of the materials in a deformation and damage process of the materials. A bionic imaging technology based on flexible traction through eyeball rotation and based on multi-spectral imaging based on the insect's compound eye is developed by using a biological template that is bionically designed and manufactured based on the insect's compound eye structure and the principle of imaging through traction of the human's eye muscles, to provide testing support for thoroughly understanding the micro-failure, deformation and damage mechanisms of the materials.

### SUMMARY

The present disclosure aims to provide a compound eye-based in-situ monitoring unit, a micro-adjustment unit, and a multi-spectral imaging system thereof, to resolve the foregoing problem in the prior art. According to the present disclosure, a limitation that a conventional material in-situ testing technology can be integrated with only one imaging characterization technology is eliminated. A plurality of imaging assemblies are combined, so that the structure evolution information of materials from the surface to the inner and from the macro to the micro can be obtained at the same time. A correlation between multi-spectral imaging information evolution and a load is established, so that micro-failure, deformation and damage mechanisms of the materials can be thoroughly understood.

To achieve the above objective, the present disclosure provides the following solutions: The present disclosure provides a compound eye-based in-situ monitoring unit, including a spherical installation cover and an imaging assembly disposed on the spherical installation cover, where the spherical installation cover is provided with a spherical grid array, the spherical grid array includes 20 installation points (five rows and four columns), one imaging assembly is installed on each installation point, the imaging assemblies include a charge coupled device (CCD) optical digital camera assembly, a digital image correlation (DIC) light source assembly, an infrared (IR) spectrum assembly, a Raman spectrum assembly, and a terahertz light source assembly.

Preferably, the CCD optical digital camera assemblies are located at four vertexes of the spherical grid array; the IR spectrum assemblies are located at inner sides, adjacent to the CCD optical digital camera assemblies, of the first and last rows of the spherical grid array; the DIC light source assemblies are located at four vertexes of the second and third rows, the Raman spectrum assemblies are located at inner sides, adjacent to the DIC light source assemblies, of the second and third rows of the spherical grid array; and four terahertz light source assemblies are centered and arranged in columns at a central axis of the spherical grid array.

Preferably, the spherical installation cover is installed on a lens holder, the lens holder is provided with a spherical groove, and the spherical installation cover is securely installed within the spherical groove.

Preferably, the spherical groove is provided with lens fixing recesses that one-to-one correspond to the installation points, a lens fixing ring is installed at a clearance in the lens fixing recess, and the lens fixing ring is threadedly connected to the imaging assembly that passes through the spherical installation cover.

The present disclosure provides a micro-adjustment unit, configured to drive the compound eye-based in-situ monitoring unit described above to realize micro adjustment, and the micro-adjustment unit includes a plurality of piezoelectric micro-motion subunits, the spherical installation cover is installed on the lens holder, the piezoelectric micro-motion subunits are disposed on top and side surfaces of the lens holder, and the piezoelectric micro-motion subunits can push the lens holder to move along a direction perpendicular to the top surface of the lens holder and a direction parallel to the top surface of the lens holder. Preferably, the piezoelectric micro-motion subunits include a first piezoelectric micro-motion subunit, a second piezoelectric micro-motion subunit, and a third piezoelectric micro-motion subunit, the first piezoelectric micro-motion subunit and the second piezoelectric micro-motion subunit are installed in a cuboid positioning recess, four first piezoelectric micro-motion subunits are installed in four corners at the bottom of the cuboid positioning recess, four second piezoelectric micro-motion subunits are installed on side walls of the cuboid positioning recess, and the second piezoelectric micro-motion subunits are coaxially disposed in pairs facing one another.

Preferably, the lens holder is clamped by using a clamping arm, the clamping arm can be rotatably connected to four pressing plates, the pressing plates can rotate to an end surface of the lens holder to clamp the lens holder, the third piezoelectric micro-motion subunit is disposed between each pressing plate and the lens holder, the third piezoelectric micro-motion subunit is fixed on the pressing plate, and the third piezoelectric micro-motion subunit and the first piezoelectric micro-motion subunit are coaxially disposed in pairs facing one another.

The present disclosure further provides a multi-spectral imaging system, including the compound eye-based in-situ monitoring unit and the micro-adjustment unit described above, where the micro-adjustment unit is connected to a six-degree-of-freedom motion unit, and the six-degree-of-freedom motion unit can drive the compound eye-based in-situ monitoring unit to perform six-degree-of-freedom motion.

Preferably, the six-degree-of-freedom motion unit includes a plurality of telescopic cylinders, a fixed platform hinged to one end of the telescopic cylinder, and a mobile platform hinged to the other end of the telescopic cylinder, hinge joints on the fixed platform and hinge joints on the mobile platform are all planarly distributed, the lens holder is installed on the mobile platform, a cuboid positioning recess is disposed on the mobile platform, and a piezoelectric micro-motion subunit is disposed in the cuboid positioning recess.

Preferably, the multi-spectral imaging system includes six telescopic cylinders that are disposed in parallel, where the fixed platform and the telescopic cylinder is connected by using a hooke joint mechanism, the mobile platform and the telescopic cylinder are connected by using a spherical pair mechanism, the hooke joint mechanisms and the spherical pair mechanisms are uniformly arranged in a triangular pattern, and two mechanisms are arranged at each vertex of a triangle.

Compared with the prior art, the present disclosure has the following technical effects:

(1) The imaging assemblies in the present disclosure include a CCD optical digital camera assembly, a DIC light source assembly, an IR spectrum assembly, a Raman spectrum assembly, and a terahertz light source assembly. By simulating an array structure of an insect's compound eye, a limitation that a conventional material in-situ testing technology can be integrated with only one imaging characterization technology is eliminated. A plurality of imaging assemblies are combined, so that the structure evolution information of materials from the surface to the inner and from the macro to the micro can be obtained at the same time. A correlation between multi-spectral imaging information evolution and a load is established, so that micro-failure, deformation and damage mechanisms of the materials can be thoroughly understood.

(2) In the present disclosure, a biological compound eye structure, a multi-spectral monitoring technology, and an in-situ testing technology for mechanical properties of the materials are integrated. By simulating an array structure of an insect's compound eye and following a principle of eye muscle traction through human eye focusing and rotation, a surface micro-morphology, temperature distribution, three-dimensional strain distribution, material compositions, and inner structural features of a material micro-domain can be synchronously monitored. Through integration with a testing instrument for the mechanical properties of the materials, multi-spectral synchronous in-situ testing based on a same position can be performed.

In this way, a correlation that is between a structure, performance, and a behavior and that is obtained through in-situ testing on the mechanical properties of the materials can be extended to a correlation between a morphology, a thermal field, a strain, a composition, a defect, performance, and a behavior, to perform synchronous lossless detection on morphologies, thermal fields, strains, compositions, and defects of the materials. In addition, a correlation between the mechanical properties of the materials and multi-spectral imaging information is established, to disclose micro-mechanisms of material deformation, damage, and failure caused by mechanical thermal coupling and other load factors. This provides technical support to disclose critical failure behaviors, performance degradation rules, and deformation and damage mechanisms of the materials under an approximately real in-service condition.

(3) In the present disclosure, a plurality of piezoelectric micro-motion subunits are disposed at the bottom and on side surfaces of a lens holder to clamp the lens holder. In addition, a position of the lens holder can be slightly adjusted, so that macro and micro control can be performed on a spatial position of a spherical installation cover based on macro-adjustment realized by telescopic cylinders. In addition, imaging paths or focuses of 20 imaging assemblies of five types can be precisely adjusted.

(4) In the present disclosure, a spherical groove of the lens holder is provided with a lens fixing recess. A lens fixing ring is disposed at a clearance in the lens fixing recess to securely install the imaging assembly. Threads are machined on an inner ring of the lens fixing ring, so that the lens fixing ring is threadedly connected to the imaging assembly. In this way, it is no longer necessary to directly provide a threaded hole within the spherical groove.

(5) In the present disclosure, the spherical installation cover is disposed within the spherical groove, and is provided with a spherical grid array configured to install the imaging assembly. In this way, the lens fixing ring can be disposed between the spherical installation cover and the spherical groove. The lens fixing recess is used to prevent horizontal motion of the lens fixing ring, and the spherical installation cover is used to prevent vertical motion of the lens fixing ring, so that the imaging assembly can be securely installed by using the lens fixing ring.

### BRIEF DESCRIPTION OF THE DRAWINGS

To describe the technical solutions in embodiments of the present disclosure or in the prior art more clearly, the accompanying drawings needed in the embodiments will be described below briefly. Apparently, the accompanying drawings in the following description show merely some embodiments of the present disclosure, and other drawings can be derived from these accompanying drawings by those of ordinary skill in the art without creative efforts.

FIG. 1 is a schematic structural diagram showing overall appearance of a bionic multi-spectral imaging system according to the present disclosure;

FIG. 2 is a view showing an imaging assembly of a bionic multi-spectral imaging system according to the present disclosure;

FIG. 3 is a schematic diagram of installing an imaging assembly on a lens holder by using a lens fixing ring according to the present disclosure;

FIG. 4 is a schematic diagram of a mobile platform and a micro-adjustment unit thereof according to the present disclosure;

FIG. 5 is a schematic diagram showing distribution of 20 imaging assemblies of five types according to the present disclosure;

FIG. 6 is a schematic structural diagram of a telescopic cylinder and its accessories according to the present disclosure; and

FIG. 7 is a schematic structural diagram of a piezoelectric micro-motion subunit according to the present disclosure.

Reference signs: 1: fixed platform; 2: hooke joint mechanism; 3: spherical pair mechanism; 4: clamping arm; 5: pressing plate; 6: spherical installation cover; 7: CCD optical digital camera assembly; 8: DIC light source assembly; 9: Raman spectrum assembly; 10: terahertz light source assembly; 11: IR spectrum assembly; 12: spherical grid array; 13: lens fixing ring; 14: lens fixing recess; 15: lens holder; 16: mobile platform; 17: telescopic cylinder; 18: first piezoelectric micro-motion subunit; 19: third piezoelectric micro-motion subunit; 20: second piezoelectric micro-motion subunit; 21: piezoelectric ceramic stack; 22: flexible hinge; 23: annular flange.

### DETAILED DESCRIPTION

The technical solutions of the embodiments of the present disclosure are clearly and completely described below with reference to the accompanying drawings. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a compound eye-based in-situ monitoring unit, a micro-adjustment unit, and a multi-spectral imaging system thereof, to resolve a problem in the prior art. According to the present disclosure, a limitation that a conventional material in-situ testing technology can be integrated with only one imaging characterization technology is eliminated. A plurality of imaging assemblies are combined, so that the structure evolution information of materials from the surface to the inner and from the macro to the micro can be obtained at the same time. A correlation between multi-spectral imaging information evolution and a load is established, so that micro-failure, deformation and damage mechanisms of the materials can be thoroughly understood.

To make the objectives, features, and advantages of the present disclosure more clearer and comprehensive, the following further describes in detail the present disclosure with reference to the accompanying drawing and specific implementations.

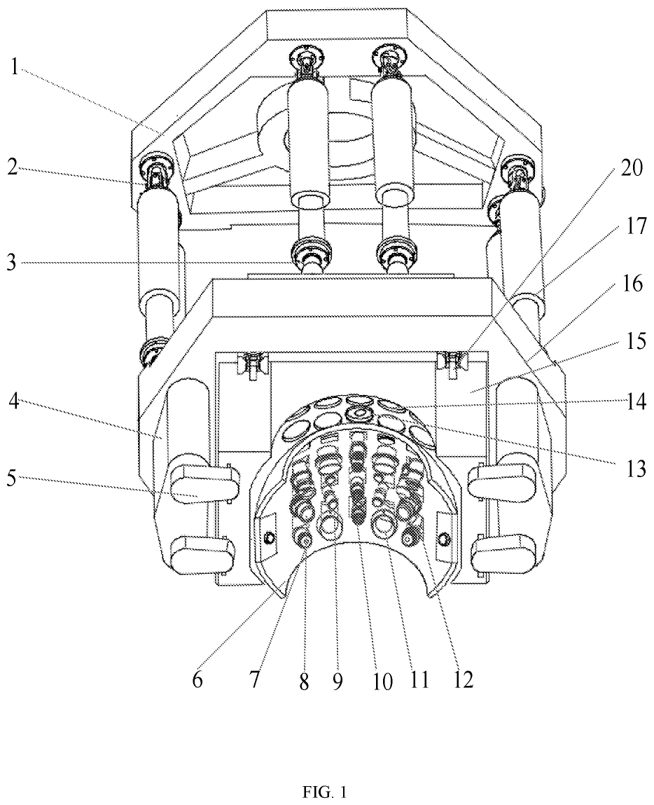

The present disclosure provides a compound eye-based in-situ monitoring unit. As shown in FIG. 1, the compound eye-based in-situ monitoring unit includes a spherical installation cover 6 and an imaging assembly disposed on the spherical installation cover 6. A proposed observation point of a tested sample is located at a virtual sphere center of the spherical installation cover 6. The spherical installation cover 6 is provided with a spherical grid array 12. The spherical grid array 12 includes 20 installation points (five rows and four columns), and one imaging assembly is installed on each installation point. The imaging assemblies include a CCD optical digital camera assembly 7, a DIC light source assembly 8, an IR spectrum assembly 11, a Raman spectrum assembly 9, and a terahertz light source assembly 10. Optical paths of all imaging assemblies intersect at a same point, namely, the proposed observation point of the tested sample. The imaging assemblies are arranged in an array form. By simulating an array structure of an insect's compound eye, a limitation that a conventional material in-situ testing technology can be integrated with only one imaging characterization technology can be broken. A plurality of imaging assemblies are combined, so that the structure evolution information of materials from the surface to the inner and from the macro to the micro can be obtained at the same time. A correlation between multi-spectral imaging information evolution and a load is established, so that micro-failure, deformation and damage mechanisms of the materials can be thoroughly understood.

As shown in FIG. 5, the CCD optical digital camera assemblies 7 are located at four vertexes of the spherical grid array 12; the IR spectrum assemblies 11 are located at inner sides, adjacent to the CCD optical digital camera assemblies 7, of the first and last rows of the spherical grid array 12; the DIC light source assemblies 8 are located at four vertexes of the second and third rows; the Raman spectrum assemblies 9 are located at inner sides, adjacent to the DIC light source assemblies 8, of the second and third rows of the spherical grid array 12; and four terahertz light source assemblies 10 are centered and arranged in columns at a central axis of the spherical grid array 12. The 20 imaging assemblies of five types are arranged in a given order. In this way, synchronous observation can be performed on structure evolution of a same micro-domain of the tested sample under a load. Therefore, a surface micro-morphology, temperature distribution, three-dimensional strain distribution, material compositions, and inner structural features of the micro-domain of the sample can be obtained at the same time by performing multi-spectral (visible light, IR, Raman light, and terahertz wave) synchronous in-situ testing based on a same position.

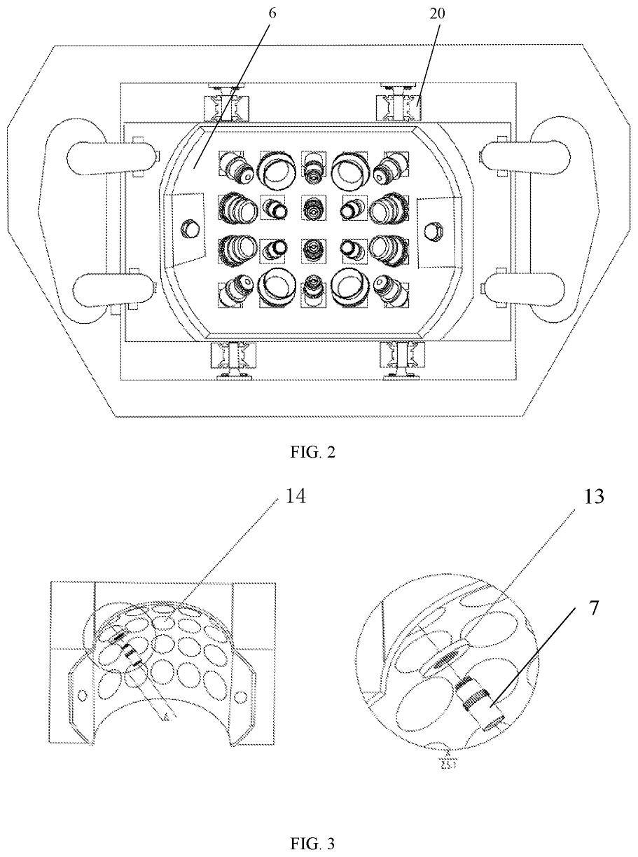

As shown in FIG. 1 and FIG. 3, the spherical installation cover 6 is installed on a lens holder 15. The lens holder 15 is provided with a spherical groove, and the spherical installation cover 6 is securely installed within the spherical groove. The optical paths of the CCD optical digital camera assembly 7, the DIC light source assembly 8, the IR spectrum assembly 11, the Raman spectrum assembly 9, and the terahertz light source assembly 10 are perpendicular to tangent planes of corresponding points on the spherical installation cover 6 and perpendicular to a tangent plane of the spherical groove of the lens holder 15. The spherical installation cover 6 and the lens holder 15 may be securely connected by using a screw. To ensure a connection effect, a part of a contact surface between the spherical installation cover 6 and the spherical groove may be machined into a plane. The plane is more convenient for machining threaded holes, so that screws can be used to secure connections.

As shown in FIG. 3, the spherical groove of the lens holder 15 is provided with lens fixing recesses 14 that one-to-one correspond to the installation points on the spherical grid array 12. The lens fixing recess 14 is a cylindrical recess, and a lens fixing ring 13 is installed at a clearance in the lens fixing recess. The lens fixing ring 13 is ring-shaped, and clearance fitting is supported for an outer diameter of the lens fixing ring 13 and an inner diameter of the lens fixing recess 14. The lens fixing ring 13 is threadedly connected to the imaging assembly that passes through the spherical installation cover 6. In other words, there are inner threads on an inner diameter side of the lens fixing ring 13, there are outer threads matching the inner threads on an outer diameter side of the imaging assembly, and a threaded connection is formed between the lens fixing ring 13 and the imaging assembly. FIG. 3 shows a connection between the CCD optical digital camera assembly 7 and the lens fixing ring 13, and the same connection manner is used for other imaging assemblies. In addition, it should be noted that the lens fixing recess 14 is provided in the spherical groove of the lens holder 15, and the lens fixing ring 13 supporting clearance fitting with the lens fixing recess 14 is disposed in the lens fixing recess 14 to securely install the imaging assembly. Threads are machined on an inner ring of the lens fixing ring 13, so that the lens fixing ring 13 is threadedly connected to the imaging assembly. This makes it no longer necessary to directly provide the threads in the spherical groove, and improves installation and securing effects while simplifying a machining process. As shown in FIG. 1, the lens fixing ring is located in a region between the spherical installation cover 6 and the spherical groove. Outer diameter dimensions of the lens fixing ring 13 should be greater than dimensions of an opening of the installation point on the spherical installation cover 6. In this way, the spherical installation cover 6 can be used to prevent vertical motion of the lens fixing ring 13, and the lens fixing recess 14 can be used to prevent horizontal motion of the lens fixing 13, so that the imaging assembly can be securely installed by using the lens fixing ring 13.

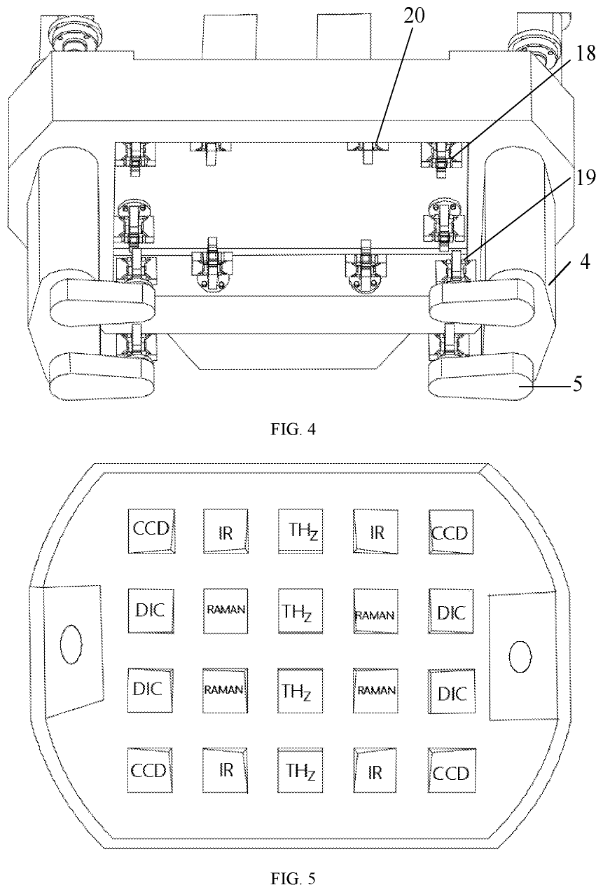

The present disclosure provides a micro-adjustment unit. The micro-adjustment unit is configured to drive a compound eye-based in-situ monitoring unit to realize micro-adjustment, and includes a plurality of piezoelectric micro-motion subunits. As shown in FIG. 7, the piezoelectric micro-motion subunits each include a flexible hinge 22 and a piezoelectric ceramic stack 21 disposed inside the flexible hinge 22. The flexible hinge 22 is controlled through expansion and contraction of the piezoelectric ceramic stack 21, to perform micro-actions. As shown in FIG. 1, FIG. 2, and FIG. 4, a spherical installation cover 6 is installed on a lens holder 15, the piezoelectric micro-motion subunits are disposed on top and side surfaces of the lens holder 15, and the piezoelectric micro-motion subunits can push the lens holder 15 to move along a direction perpendicular to the top surface of the lens holder 15 and a direction parallel to the top surface of the lens holder 15.

As shown in FIG. 4, the piezoelectric micro-motion subunits include a first piezoelectric micro-motion subunit 18, a second piezoelectric micro-motion subunit 20, and a third piezoelectric micro-motion subunit 19. It should be noted that the three piezoelectric micro-motion subunits may have a same structure to facilitate control and installation. The first piezoelectric micro-motion subunit 18 and the second piezoelectric micro-motion subunit 20 are installed in a cuboid positioning recess. As shown in FIG. 7, the piezoelectric micro-motion subunit includes an annular flange 23 configured to install the piezoelectric micro-motion subunit in the cuboid positioning recess by using a screw. In the cuboid positioning recess, four first piezoelectric micro-motion subunits 18 are installed at the bottom, and four second piezoelectric micro-motion subunits 20 are installed on side walls, and the second piezoelectric micro-motion subunits 20 are coaxially disposed in pairs facing one another. The first piezoelectric micro-motion subunit 18 can adjust a direction perpendicular to a bottom plane of the cuboid positioning recess, in other words, push the lens holder 15 to move along the direction perpendicular to the top surface of the lens holder 15. The second piezoelectric micro-motion subunit 20 can adjust a direction parallel to the bottom plane of the cuboid positioning recess, in other words, push the lens holder 15 to move along the direction parallel to the top surface of the lens holder 15. In this way, a vertical deflection angle of the spherical installation cover 6 can be controlled.

As shown in FIG. 1 and FIG. 2, the lens holder 15 is clamped by using a clamping arm 4. The clamping arm 4 can be rotatably connected to four pressing plates 5. The pressing plates 5 can rotate to an end surface of the lens holder 15 to clamp the lens holder 15, and rotate to an opposite direction to remove the lens holder 15. Therefore, the pressing plates 5 can be used to fast install and remove the lens holder 15. Generally, the pressing plates 5 should be arranged in different directions of the lens holder 15, and preferably, are arranged in four corners of the end surface of the lens holder 15. In this case, the clamping arms 4 one-to-one correspond to the pressing plates 5, or two pressing plates 5 are disposed on one clamping arm 4. The pressing plates 5 may be rotated manually or electrically. A specific mechanical structure of the pressing plate 5 is known in the art and is not described herein. Refer to FIG. 4. The third piezoelectric micro-motion subunit 19 is disposed between each pressing plate 5 and the lens holder 15, the third piezoelectric micro-motion subunit 19 is securely installed on the pressing plate 5 by using the annular flange 23, and the third piezoelectric micro-motion subunit 19 and the first piezoelectric micro-motion subunit 18 are coaxially disposed in pairs facing one another. The first piezoelectric micro-motion subunit 18 and the third piezoelectric micro-motion subunit 19 can preload the spherical installation cover 6. When the first piezoelectric micro-motion subunit 18 and the third piezoelectric micro-motion subunit 19 output different displacements, they can cooperate with each other to control a vertical height or a horizontal deflection angle of the spherical installation cover 6.

The present disclosure further provides a multi-spectral imaging system. As shown in FIG. 1, the system includes a compound eye-based in-situ monitoring unit and a micro-adjustment unit. The micro-adjustment unit is connected to a six-degree-of-freedom motion unit, and the six-degree-of-freedom motion unit can drive the compound eye-based in-situ monitoring unit to perform six-degree-of-freedom motion. It should be noted that the six-degree-of-freedom motion unit may be of a structure in the prior art, for example, a six-degree-of-freedom motion platform.

As shown in FIG. 1, the six-degree-of-freedom motion unit includes a plurality of telescopic cylinders 17, a fixed platform 1 hinged to one end of the telescopic cylinder 17, and a mobile platform 16 hinged to the other end of the telescopic cylinder 17. Hinge joints on the fixed platform 1 and hinge joints on the mobile platform 16 are all planarly distributed. In other words, the hinge joints cannot be arranged in a straight line, so that the mobile platform 16 can be driven by the telescopic cylinder 17 to perform six-degree-of-freedom motion. A lens holder 15 is installed on the mobile platform 16. Piezoelectric micro-motion subunits are disposed between the lens holder 15 and the mobile platform 16. Specifically, a cuboid positioning recess is disposed on the mobile platform 16, and the piezoelectric micro-motion subunits are disposed at the bottom and on side walls of the cuboid positioning recess. The piezoelectric micro-motion subunits can be used to compress the lens holder 15 and perform micro-adjustment on a position of the lens holder 5.

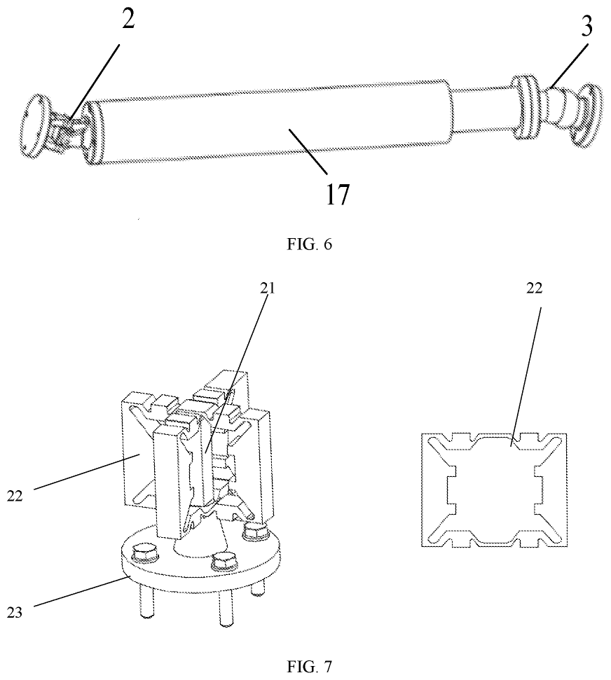

As shown in FIG. 1, further, the six-degree-of-freedom motion unit may include six telescopic cylinders 17 that are disposed in parallel. As shown in FIG. 6, the telescopic cylinder 17 may be an electric servo cylinder, and its two ends are respectively provided with a hooke joint mechanism 2 and a spherical pair mechanism 3. The fixed platform 1 and the telescopic cylinder 17 are connected by using the hooke joint mechanism 2, and the mobile platform 16 and the telescopic cylinder 17 are connected by using the spherical pair mechanism 3. The hooke joint mechanisms and the spherical pair mechanisms are uniformly arranged in a triangular pattern, and two mechanisms are arranged at each vertex of a triangle. Spatial poses of the mobile platform 16 and the lens holder 15 are adjusted in real time by adjusting lengths of the six telescopic cylindersl7 and through collaborative motion between the six telescopic cylinders 17, to further perform macro-positioning on the spherical installation cover 6. In addition, fine control over a multi-spectral optical path and zoom imaging are realized based on the functions of the piezoelectric micro-motion subunits of the micro-adjustment unit. It should be noted that the 20 spherical grid arrays 12 and the 20 imaging assemblies of five types on the spherical installation cover 6 use an insect's compound eye structure as a bionic template. The six-degree-of-freedom motion unit and the micro-adjustment unit simulate a principle of eye muscle traction through human eye focusing and rotation. The system has open imaging space, and can be integrated with a vertical or horizontal instrument for testing mechanical properties of materials, to synchronously monitor a surface micro-morphology, temperature distribution, three-dimensional strain distribution, material compositions, and inner structural features of a material micro-domain under a load. In addition, a stress-strain relationship and a real-time correlation between a morphology, a thermal field, a strain, a composition, and a defect are established for the materials.

The present disclosure further provides a specific embodiment of a multi-spectral imaging system.

Dimensions of a main body of the imaging system may be set as 1278 mm×996 mm×1478 mm. An inner spherical radius of a spherical installation cover 6 in the system may be 300 mm, and a thickness may be 15 mm.

Models of components in this embodiment are as follows:

A telescopic cylinder 17 is an electric servo cylinder. For the electric servo cylinder, a reference model is ROB30×500, a reference stroke is 500 mm, a reference outer diameter is 30 mm, and a reference rod diameter is 25 mm.

A reference model of a CCD optical digital camera assembly 7 is PZ-140D.

A reference model of a DIC light source assembly 8 is MA-100F(2×/0.055).

A reference model of an IR spectrum assembly 11 is 13VG308ASIRII.

A reference model of a Raman spectrum assembly 9 is RTS200-VIS-NIR.

A reference model of a terahertz light source assembly 10 is EV-TOL.

A first piezoelectric micro-motion subunit 18, a second piezoelectric micro-motion subunit 20, and a third piezoelectric micro-motion subunit 19 use a same piezoelectric ceramic stack 21, and a reference model is PZT-82Φ10.033×Φ14.95×2.997.

A working principle and a testing process of the multi-spectral imaging system in the present disclosure are as follows:

In the testing process, according to an arrangement order shown in FIG. 5, the CCD optical digital camera assembly 7, the DIC light source assembly 8, the IR spectrum assembly 11, the Raman spectrum assembly 9, and the terahertz light source assembly 10 are installed on the spherical installation cover 6 by using corresponding outer threads on end surfaces of these assemblies and are connected to lens fixing rings 13 in the spherical groove by using inner threads of the lens fixing rings 13. A human's eyeball and its surrounding muscle group are used as a biological model. Kinematics and dynamics characteristics of the eyeball in a centered rotation process are analyzed to obtain a motion gait of the eyeball and a quantitative mathematical description of eye muscle contraction, to establish a bionic model for multi-degree-of-freedom motion of the eyeball and flexible traction of eye muscles. Based on theoretical analysis of traction tension, a rotation stroke, a motion speed, according to actual imaging conditions and requirements, a time sequence control criterion of the six-degree-of-freedom motion unit and the micro-adjustment unit is established. Based on research on biomechanical properties and a flexible traction mechanism of eye muscles, a correlation between a stroke, a speed, reversing, inertial impact, and a flexible traction load/displacement of eyeball rotation is established to analyze a self-locking mechanism for high-precision positioning of the spherical installation cover 6, and a manner of implementing the self-locking mechanism. Quantitative analysis is performed on rotation and traction tension of the spherical installation cover 6 to analyze a multi-freedom bionic flexible driving strategy supporting fast, wide-angle, and full-field-of-view monitoring within narrow imaging space. A kinematics model incorporating a maximum speed, a swing angle, and a reversing acceleration of motion of a multi-spectral in-situ imaging assembly, and a coupled physical model incorporating six-degree-of-freedom motion, precise focusing, and object recognition are established, and used to determine a deformation degree and an acceleration characteristic of the spherical installation cover 6 at an extreme swing angle position and in a reversing process. Further, output displacements of six telescopic cylinders 17 of the six-degree-of-freedom motion unit and 12 piezoelectric micro-motion subunits (including the first piezoelectric micro-motion subunit 18, the second piezoelectric micro-motion subunit 20, and the third piezoelectric micro-motion subunit 19) of the micro-adjustment unit are adjusted, to precisely adjust a horizontal position, a vertical position, and a deflection angle of the spherical installation cover 6, and further control imaging paths or focuses of 20 imaging assemblies of five types, thereby realizing synchronous multi-spectral imaging in a micro-domain of an observed sample.

Specific embodiments are used for illustration of the principles and implementations of the present disclosure. The description of the embodiments is only used to help illustrate the method and its core ideas of the present disclosure. In addition, persons of ordinary skill in the art can make various modifications in terms of specific embodiments and scope of application in accordance with the teachings of the present disclosure. In conclusion, the content of this specification should not be construed as a limitation to the present disclosure.

What is claimed is:

1. A compound eye-based in-situ monitoring unit, comprising a spherical installation cover and an imaging assembly disposed on the spherical installation cover, wherein the spherical installation cover is provided with a spherical grid array, the spherical grid array comprises 20 installation points (five rows and four columns), one imaging assembly is installed on each installation point, the imaging assemblies comprise a charge coupled device (CCD) optical digital camera assembly, a digital image correlation (DIC) light source assembly, an infrared (IR) spectrum assembly, a Raman spectrum assembly, and a terahertz light source assembly.

2. The compound eye-based in-situ monitoring unit according to claim 1, wherein the CCD optical digital camera assemblies are located at four vertexes of the spherical grid array; the IR spectrum assemblies are located at inner sides, adjacent to the CCD optical digital camera assemblies, of the first and last rows of the spherical grid array; the DIC light source assemblies are located at four vertexes of the second and third rows; the Raman spectrum assemblies are located at inner sides, adjacent to the DIC light source assemblies, of the second and third rows of the spherical grid array; and four terahertz light source assemblies are centered and arranged in columns at a central axis of the spherical grid array.

3. The compound eye-based in-situ monitoring unit according to claim 2, wherein the spherical installation cover is installed on a lens holder, the lens holder is provided with a spherical groove, and the spherical installation cover is securely installed within the spherical groove.

4. The compound eye-based in-situ monitoring unit according to claim 3, wherein the spherical groove is provided with lens fixing recesses that one-to-one correspond to the installation points, a lens fixing ring is installed at a clearance in the lens fixing recess, and the lens fixing ring is threadedly connected to the imaging assembly that passes through the spherical installation cover.

5. A micro-adjustment unit, wherein the micro-adjustment unit is configured to drive the compound eye-based in-situ monitoring unit according to claim 1 to realize micro adjustment, and comprises a plurality of piezoelectric micro-motion subunits, the spherical installation cover is installed on the lens holder, the piezoelectric micro-motion subunits are disposed on top and side surfaces of the lens holder, and the piezoelectric micro-motion subunits can push the lens holder to move along a direction perpendicular to the top surface of the lens holder and a direction parallel to the top surface of the lens holder.

6. A micro-adjustment unit, wherein the micro-adjustment unit is configured to drive the compound eye-based in-situ monitoring unit according to claim 2 to realize micro adjustment, and comprises a plurality of piezoelectric micro-motion subunits, the spherical installation cover is installed on the lens holder, the piezoelectric micro-motion subunits are disposed on top and side surfaces of the lens holder, and the piezoelectric micro-motion subunits can push the lens holder to move along a direction perpendicular to the top surface of the lens holder and a direction parallel to the top surface of the lens holder.

7. A micro-adjustment unit, wherein the micro-adjustment unit is configured to drive the compound eye-based in-situ monitoring unit according to claim 3 to realize micro adjustment, and comprises a plurality of piezoelectric micro-motion subunits, the spherical installation cover is installed on the lens holder, the piezoelectric micro-motion subunits are disposed on top and side surfaces of the lens holder, and the piezoelectric micro-motion subunits can push the lens holder to move along a direction perpendicular to the top surface of the lens holder and a direction parallel to the top surface of the lens holder.

8. A micro-adjustment unit, wherein the micro-adjustment unit is configured to drive the compound eye-based in-situ monitoring unit according to claim 4 to realize micro adjustment, and comprises a plurality of piezoelectric micro-motion subunits, the spherical installation cover is installed on the lens holder, the piezoelectric micro-motion subunits are disposed on top and side surfaces of the lens holder, and the piezoelectric micro-motion subunits can push the lens holder to move along a direction perpendicular to the top surface of the lens holder and a direction parallel to the top surface of the lens holder.

9. The micro-adjustment unit according to claim 5, wherein the piezoelectric micro-motion subunits comprise a first piezoelectric micro-motion subunit, a second piezoelectric micro-motion subunit, and a third piezoelectric micro-motion subunit, the first piezoelectric micro-motion subunit and the second piezoelectric micro-motion subunit are installed in a cuboid positioning recess, four first piezoelectric micro-motion subunits are installed in four corners at the bottom of the cuboid positioning recess, four second piezoelectric micro-motion subunits are installed on side walls of the cuboid positioning recess, and the second piezoelectric micro-motion subunits are coaxially disposed in pairs facing one another.

10. The micro-adjustment unit according to claim 6, wherein the piezoelectric micro-motion subunits comprise a first piezoelectric micro-motion subunit, a second piezoelectric micro-motion subunit, and a third piezoelectric micro-motion subunit, the first piezoelectric micro-motion subunit and the second piezoelectric micro-motion subunit are installed in a cuboid positioning recess, four first piezoelectric micro-motion subunits are installed in four corners at the bottom of the cuboid positioning recess, four second piezoelectric micro-motion subunits are installed on side walls of the cuboid positioning recess, and the second piezoelectric micro-motion subunits are coaxially disposed in pairs facing one another.

11. The micro-adjustment unit according to claim 7, wherein the piezoelectric micro-motion subunits comprise a first piezoelectric micro-motion subunit, a second piezoelectric micro-motion subunit, and a third piezoelectric micro-motion subunit, the first piezoelectric micro-motion subunit and the second piezoelectric micro-motion subunit are installed in a cuboid positioning recess, four first piezoelectric micro-motion subunits are installed in four corners at the bottom of the cuboid positioning recess, four second piezoelectric micro-motion subunits are installed on side walls of the cuboid positioning recess, and the second piezoelectric micro-motion subunits are coaxially disposed in pairs facing one another.

12. The micro-adjustment unit according to claim 8, wherein the piezoelectric micro-motion subunits comprise a first piezoelectric micro-motion subunit, a second piezoelectric micro-motion subunit, and a third piezoelectric micro-motion subunit, the first piezoelectric micro-motion subunit and the second piezoelectric micro-motion subunit are installed in a cuboid positioning recess, four first piezoelectric micro-motion subunits are installed in four corners at the bottom of the cuboid positioning recess, four second piezoelectric micro-motion subunits are installed on side walls of the cuboid positioning recess, and the second piezoelectric micro-motion subunits are coaxially disposed in pairs facing one another.

13. The micro-adjustment unit according to claim 9, wherein the lens holder is clamped by using a clamping arm, the clamping arm can be rotatably connected to four pressing plates, the pressing plates can rotate to an end surface of the lens holder to clamp the lens holder, the third piezoelectric micro-motion subunit is disposed between each pressing plate and the lens holder, the third piezoelectric micro-motion subunit is fixed on the pressing plate, and the third piezoelectric micro-motion subunit and the first piezoelectric micro-motion subunit are coaxially disposed in pairs facing one another.

14. The micro-adjustment unit according to claim 10, wherein the lens holder is clamped by using a clamping arm, the clamping arm can be rotatably connected to four pressing plates, the pressing plates can rotate to an end surface of the lens holder to clamp the lens holder, the third piezoelectric micro-motion subunit is disposed between each pressing plate and the lens holder, the third piezoelectric micro-motion subunit is fixed on the pressing plate, and the third piezoelectric micro-motion subunit and the first piezoelectric micro-motion subunit are coaxially disposed in pairs facing one another.

15. The micro-adjustment unit according to claim 11, wherein the lens holder is clamped by using a clamping arm, the clamping arm can be rotatably connected to four pressing plates, the pressing plates can rotate to an end surface of the lens holder to clamp the lens holder, the third piezoelectric micro-motion subunit is disposed between each pressing plate and the lens holder, the third piezoelectric micro-motion subunit is fixed on the pressing plate, and the third piezoelectric micro-motion subunit and the first piezoelectric micro-motion subunit are coaxially disposed in pairs facing one another.

16. The micro-adjustment unit according to claim 12, wherein the lens holder is clamped by using a clamping arm, the clamping arm can be rotatably connected to four pressing plates, the pressing plates can rotate to an end surface of the lens holder to clamp the lens holder, the third piezoelectric micro-motion subunit is disposed between each pressing plate and the lens holder, the third piezoelectric micro-motion subunit is fixed on the pressing plate, and the third piezoelectric micro-motion subunit and the first piezoelectric micro-motion subunit are coaxially disposed in pairs facing one another.

17. A multi-spectral imaging system, comprising the compound eye-based in-situ monitoring unit and the micro-adjustment unit according to claim 1, wherein the micro-adjustment unit is connected to a six-degree-of-freedom motion unit, and the six-degree-of-freedom motion unit can drive the compound eye-based in-situ monitoring unit to perform six-degree-of-freedom motion.

18. The multi-spectral imaging system according to claim 17, wherein the six-degree-of-freedom motion unit comprises a plurality of telescopic cylinders, a fixed platform hinged to one end of the telescopic cylinder, and a mobile platform hinged to the other end of the telescopic cylinder, hinge joints on the fixed platform and hinge joints on the mobile platform are all planarly distributed, the lens holder is installed on the mobile platform, a cuboid positioning recess is disposed on the mobile platform, and a piezoelectric micro-motion subunit is disposed in the cuboid positioning recess.

19. The multi-spectral imaging system according to claim 18, comprising six telescopic cylinders that are disposed in parallel, wherein the fixed platform and the telescopic cylinder is connected by using a hooke joint mechanism, the mobile platform and the telescopic cylinder are connected by using a spherical pair mechanism, the hooke joint mechanisms and the spherical pair mechanisms are uniformly arranged in a triangular pattern, and two mechanisms are arranged at each vertex of a triangle.
